(19) United States
(12) Patent Application Publication
(10) Pub. No.: US 2002/0001358 A1
(43) Pub. Date: Jan. 3, 2002

(54) Method for fast synchronization of block encoders and decoders in block-coded bidirectional data transmission via a bit-oriented channel

(76) Inventor: Jurgen Graf, Blaubeuren (DE)

Correspondence Address: LERNER AND GREENBERG, P.A., Post Office Box 2480, Hollywood, FL, 33022-2480, US

(21) Appl. No.: 09/886,563

(22) Filed: Jun. 21, 2001

(30) Foreign Application Priority Data
Jun. 21, 2000 (DE) 100 30 393.5

(51) Int. Cl. H04L 7/00

(52) U.S. Cl. 375/354

(57) ABSTRACT

Transmission devices that are disposed at a transmitting and a receiving end are synchronized in a block-coded bidirectional data transmission via a bit-oriented channel. The transmission devices assume an asynchronous synchronization state at the beginning of the data transmission and in each case transmit first flags to the opposite end, and each of the transmission devices first synchronizes to the received first flags and/or further flags. When one of the two transmission devices has successfully synchronized, the further flags are transmitted to the opposite end until no further first flags are received by the opposite end and synchronism has thus been achieved at both transmission devices. Thereupon, data transmission can be begun.

### BACKGROUND OF THE INVENTION

Field of the Invention

The invention pertains to method of synchronizing transmission devices in block-coded bidirectional data transmission via a bit-oriented channel, wherein transmission devices are arranged at a transmitting end and a receiving end.

In synchronous transmissions of binary data via a bit-oriented channel, the clock must be recovered at the receiving end. This is the only way in which the receiver is able to correctly detect and extract the data. A bit-oriented channel is understood to be the transmission of data without a higher-level frame structure. For the clock recovery to be possible, the transmitter must guarantee that the transition density (transitions from 0 to 1 and conversely) is sufficiently high. However, this is influenced by the physical state of the transmission link. The data must, therefore, be adapted to the transmission situation. For this purpose, block encoders are used. At the transmitting end, concatenated coded blocks of equal length are transmitted which are decoded at the receiving end. However, decoding is only possible if the block boundaries are reliably detected. The receiving decoder must thus be synchronized to the block boundaries.

In networks with protection switching, this synchronization must be done as quickly as possible so that the fewest possible data items are lost.

Previous solution methods have the disadvantage that the dynamic response of the transmission process is impaired.

### SUMMARY OF THE INVENTION

It is accordingly an object of the invention to provide a method of synchronizing transmission devices in block-coded bidirectional data transmission via a bit-oriented channel, which overcomes the above-mentioned disadvantages of the heretofore-known devices and methods of this general type and which provides for a novel approach to how fast synchronization to block boundaries can be performed with simple means.

With the foregoing and other objects in view there is provided, in accordance with the invention, a method of synchronizing transmission devices in a block-coded bidirectional data transmission via a bit-oriented channel, wherein transmission devices are disposed at a transmitting end and at a receiving end. The method comprises the following steps:

placing the two transmission devices into an asynchronous synchronization state at a beginning of a data transmission and in each case transmitting first flags to a respectively opposite end, and first synchronizing each of the transmission devices to one of the first flags and further flags received thereby; and upon a successful synchronization by one of the two transmission devices, transmitting the further flags to the opposite end until no further first flags are received by the opposite end and synchronism has thus been achieved at both transmission devices, and subsequently starting a data transmission.

The advantageous factor in the invention is that it provides fast synchronization of block encoding systems. The method according to the invention can be applied to any block code having block lengths of greater than 1. Using the two flags as synchronization aid makes it possible to inform the opposite end of one's own synchronization state even if it is not yet synchronized. This does not disturb the synchronization process. As a result, it is possible to detect immediately that the opposite end is synchronous, and the transmission of user data can be started.

In accordance with a concomitant feature of the invention, the transmission devices are coding systems comprising one of block encoders and block decoders.

Although the invention is illustrated and described herein as embodied in a method for fast synchronization of block encoders and decoders in a block-coded bidirectional data transmission via a bit-oriented channel, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a state diagram of the synchronization method according to the invention;

FIG. 2 is a block diagram illustrating a solution with correlation before the decoder;

FIG. 3 is a block diagram of a solution with correlation without offset detection before the decoder; and

FIG. 4 is a block diagram of a solution with synchronization after the decoder.

### DESCRIPTION OF THE PREFERRED EMBODIMENTS

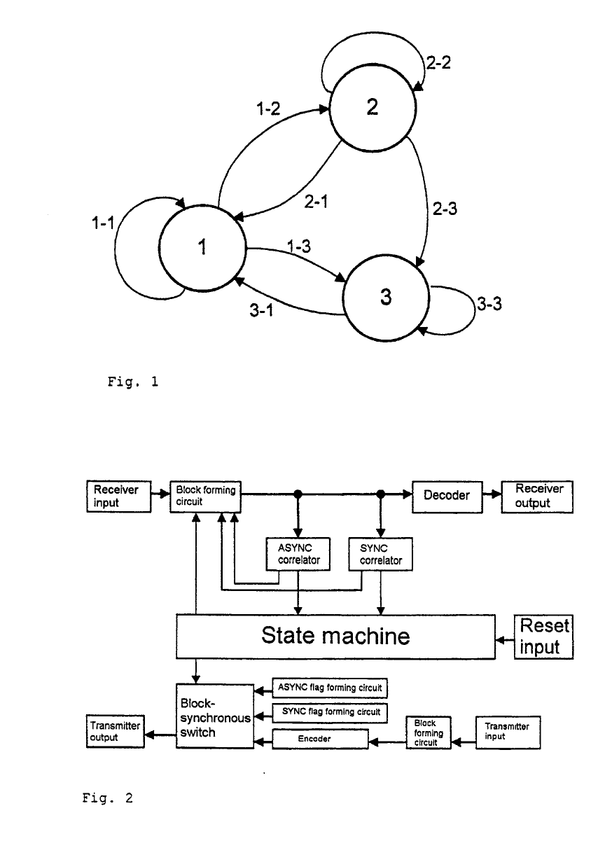

Referring now to the figures of the drawing in detail and first, particularly, to FIG. 1 thereof, there is shown a state diagram of the synchronization method. As a prerequisite, a bidirectional transmission link is considered. The coded blocks to be transmitted via this link should always have the same length (same number of bits) and be seamlessly concatenated. This means that the start-off-block boundaries are always arranged at the same distance from one another. It is, therefore, completely sufficient to synchronize the block decoder of the receiver only once, namely at the beginning of data transmission.

To perform the synchronization, synchronization aids in the form of concatenated synchronization flags are transmitted. At the receiving end, the block boundaries can be detected by means of these flags. The actual user data which are sent as block-encoded data blocks are only transmitted when it has been detected that the opposite end is reliably block-synchronous. The respective opposite end is informed of the synchronization status by the synchronization flags. For this purpose, the method uses two different synchronization flags, namely, an ASYNC flag and a SYNC flag. The ASYNC flag informs the opposite end that there is not yet own synchronism to the block boundaries. The SYNC flag informs that own synchronism with the block boundaries is given. For this purpose, the two flags must fulfill the following characteristics:

a) There must be no period within a flag.

b) Both flags must have the same length.

c) A flag must have the length of a data block to be encoded (or a multiple thereof).

d) If flags are periodically concatenated, the bit sequence produced must not contain any sequence which corresponds to the other flag.

e) When concatenated flags are sent, the transition density must be high enough.

At the beginning of the synchronization process, the two encoding systems are set to the initial state 1 (“asynchronous”) by a reset pulse (Reset). In this context, a coding system is understood to be one of the configurations shown in FIGS. 2-4. Each of the two coding systems operates in accordance with the state diagram shown in FIG. 1.

State 1 (Coding System is Asynchronous):

Concatenated ASYNC flags are sent. Attempts are made here to detect the block boundaries by means of the incoming synchronization flags and to synchronize to these.

State 2 (Coding System is Synchronous and the Opposite End is Asynchronous):

Concatenated SYNC flags are sent. The SYNC flags are sent without offset with respect to the ASYNC flags sent previously. This means that the periodic position of the block boundaries does not shift for the opposite end.

State 3 (Both Coding Systems are Synchronous):

No further synchronization flags are sent but concatenated coded blocks (user data). The coded blocks are sent without of fset with respect to the ASYNC flags or SYNC flags previously sent. That is to say the periodic position of the block boundaries does not shift for the opposite end.

Transition 1-1:

The block boundaries have not been reliably detected (there is no block synchronism established as yet) or a reset was generated by an external position.

Transition 1-2:

The block boundaries have been reliably detected. Typically, an adequate number (e.g. 3-10) of successive error-free ASYNC flags must be correctly received. Block synchronism is established.

Transition 1-3:

The block boundaries have been reliably detected. Typically, an adequate number (e.g. 3-10) of successive, error-free ASYNC flags or SYNC flags must be correctly received. Block synchronism is established. At the least, an adequate number of SYNC flags must have been received last.

Transition 2-2:

The reception of ASYNC flags has been reliably detected.

Transition 2-3:

It has been reliably detected that no further ASYNC flags are received. Typically, an adequate number of ASYNC flags (number: 3-10) has no longer been received in succession.

Transition 2-1:

Reset has been generated from an external position.

Transition 3-3:

No reset has been generated from an external position.

Transition 3-1:

Reset has been generated from an external position.

The prerequisite for transitions 1-2, 1-3, 2-2, 2-3, 3-3 is that no reset has been generated. Depending on the block code used, a reset can be generated not only by an external position but also in the case of code violations occurring too frequently.

The following text outlines an example of a synchronization process.

Let us presume, in the example, that both coding systems assume an asynchronous synchronization state. Both are sending ASYNC flags. The coding system arranged at the receiving end first synchronizes to the received ASYNC flag and then, in turn, sends SYNC flags. The coding system arranged at the transmitting end synchronizes to the SYNC flag and begins a normal data transmission. The coding system arranged at the receiving end then receives no further ASYNC flags and also begins data transmission.

A further development consists in receiving ASYNC flags in state 3. This leads to a transition into state 2. This makes it possible to request a needed synchronization aid from the opposite end. The prerequisite for this is that the ASYNC flag cannot occur in normal operation. This means that at least one block contains the flag (flag can consist of a number of blocks) which does not occur in the block code used. The only differences from the above state diagram are found in the new transition 3-2.

Transition 3-2:

The reception of ASYNC flags has been reliably detected. For this purpose, an adequate number (3-10) of successive error-free ASYNC flags must be usually received.

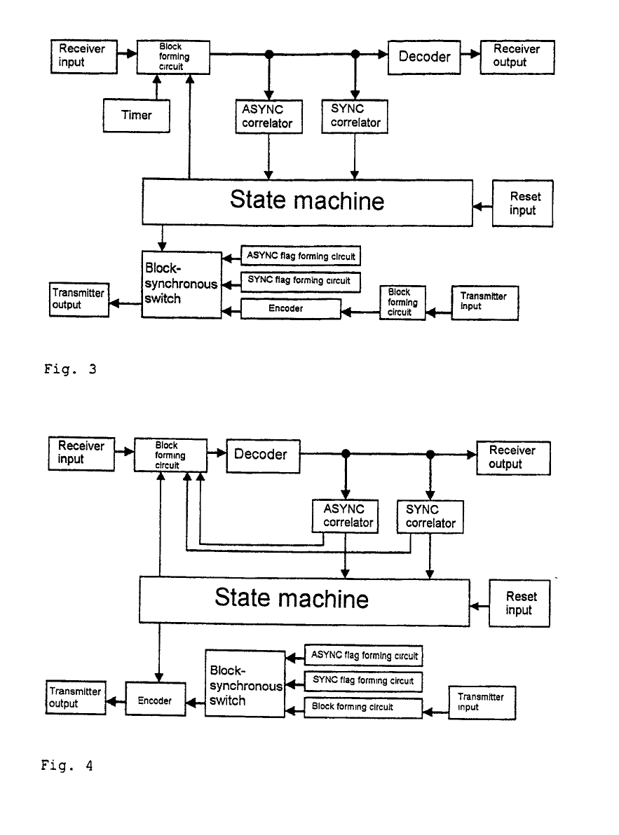

This variation only functions if the flags are evaluated before the decoder (as, for example, in the devices according to FIGS. 2, 3).

FIG. 2 shows a solution of a coding system with a correlation before the decoder. In this system, the individual blocks serve the following task:

The transmitter input forwards the data to be coded to a block forming circuit (transmitter).

The block forming circuit (transmitter) receives data at its input. The data can be bit-oriented or also already block-oriented. From the data, a block-oriented data stream is generated. The block size corresponds to the length of the data block to be coded by the subsequent encoder (block size N). This means that the data stream also provides information relating to the block boundaries to the subsequent encoder. The individual blocks all have the same length.

The encoder receives the data blocks (block size N) to be coded from the block forming circuit (transmitter) and codes it into blocks with block size M. At the output, block-coded data are present. The block boundaries are known to the subsequent selection switch.

An ASYNC flag forming circuit forms a block which has the same length as a coded block, or a multiple (block size k*M). The content of the block consists of the ASYNC flag. At the output, this data block is provided to the selection switch (block-synchronous switch). The flag length is known to the subsequent switch.

A SYNC flag forming circuit forms a block which has the same length as a coded block, or a multiple (block size k*M). The content of the block consists of the SYNC flag. At the output, this data block is provided to the selection switch. The flag length is known to the subsequent switch. The block-synchronous switch is controlled by the state machine, which controls the selection of the data block to be forwarded from the three inputs (ASYNC flag forming circuit, SYNC flag forming circuit, and encoder). Switching is done block-synchronously (switching only occurs at the block boundaries or flag boundaries, block size M, flag size k*M). The flags or blocks present at the inputs are always sent complete. There are no gaps between the individual blocks. The blocks selected are forwarded to the “transmitter output.”

The transmitter output fulfills no other function.

A receiver input receives the data of the opposite end and forwards them to the block forming circuit. The incoming data stream is still bit-oriented. However, it contains concatenated data blocks coded by the opposite end. However, no information on the block boundaries is forwarded.

A block forming circuit (receiver) generates a block-oriented data stream from the bit-oriented data stream. That means that the subsequent correlators (for ASYNC and SYNC) and the decoder also receive information on the block boundaries in addition to the data stream. The individual blocks all have the same length. The length of the data blocks corresponds to the length of a block to be decoded (block size M). The block forming circuit cannot by itself check whether these block boundaries, which initially have been arbitrarily assumed, are also correct. The block forming circuit, therefore, has a set input, which is connected to the state machine, and in each case one input which are connected to the respective correlators. Correlators can determine the correct position of the actual block boundaries with respect to the initially random block boundaries of the block forming circuit (offset) on the basis of the respective flag. Information relating to the actual block boundaries is present at both inputs. The set input makes it possible to select which of the two is to be accepted. After the setting, the block forming circuit is correctly set and the block boundaries now correspond to the actual block boundaries.

The decoder receives, at its input, block-oriented data (block size M, data and information relating to block boundaries). The block boundaries may be incorrect during the synchronization process. It decodes the data blocks and forwards the decoder data to the “receiver output” (block size N).

The ASYNC correlator receives, at its input, block-oriented data blocks (data and information relating to block boundaries, block size M). The block boundaries may be incorrect during the synchronization process. If ASYNC flags are sent by the opposite end, this enables the correlator to detect that the ASYNC flag is sent. In addition, it is also capable of detecting the accurate block boundaries by means of the “ASYNC flags.” This information is present at the output which is connected to the block forming circuit. The other output is connected to the state machine. The ASYNC correlator thus informs the state machine of whether or not the ASYNC flag has been received. Since a flag consists of k blocks (block size M), it always takes into consideration k successive blocks.

The SYNC correlator receives, at its input, block-oriented data blocks (data and information relating to block boundaries, block size M). The block boundaries may be incorrect during the synchronization process. If SYNC flags are sent by the opposite end, this enables the correlator to detect that the SYNC flag is sent. In addition, it can also detect the precise block boundaries by means of the “SYNC flags”. This information is present at the output which is connected to the block forming circuit. The other output is connected to the state machine. It informs the state machine of whether or not the SYNC flag has been received. Since a flag consists of k blocks (block size M), it always takes into consideration k successive blocks.

The state machine (also referred to as a finite state machine) here has three states, which are outlined in the following: A reset places the state machine into state 1 (“asynchronous”). In this state, the “block-synchronous switch” is set to accepting the “ASYNC flags.” As soon as one of the two correlators at the input signals that it has found a valid flag (ASYNC or SYNC flag), it changes into another state. If the flag found is an ASYNC flag, it changes into state 2 (“synchronous and opposite end asynchronous”). The state machine then initiates setting the correct block boundaries (“receiver block forming circuit”). This means that the acceptance of the block boundary information of the ASYNC correlator is initiated at the “receiver block forming circuit”. If the flag found is a SYNC flag, it changes into state 3 (“both synchronous”). The state machine then initiates setting the correct block boundaries (“receiver block forming circuit”). This means that the acceptance of the block boundary information of the SYNC correlator is initiated at the “receiving block forming circuit”.

In state 2 (“synchronous and opposite end asynchronous”), the SYNC flag is then sent to the opposite end. This means that the “block-synchronous switch” receives corresponding information on the selection of the SYNC flag. If no further ASYNC flag is received in this state, this means that the opposite end is synchronous. The state machine changes into state 3 (“both synchronous”). With this transition, it is no longer necessary to set the “receiver block forming circuit” since the block boundaries were already correct in state 2 (“synchronous and opposite end asynchronous”). In state 3 (“both synchronous”), the coded data have been sent. This means that the “block synchronous switch” receives information on the selection of the data from the encoder. It is only possible to return from this state into state 1 by a reset. (If the ASYNC flag does not occur in the normal data stream, reliable reception of ASYNC flags can also lead to a transition into state 1.) The state machine can be set to the initial state 1 (“asynchronous”) from each of the 3 states by a reset.

A reset input to the state machine enables a reset signal to be input into the state machine.

FIG. 3 shows a solution with correlation without offset detection before the decoder:

The differences as compared with the configuration of FIG. 2 are as follows:

The block forming circuit (transmitter) provides a possibility of shifting the block boundaries by one single bit. This shifting mechanism is controlled by two inputs: an input from the state machine for suppressing the shifting mechanism and the input from the timer which supplies the pulse for shifting one bit.

A timer supplies a pulse for shifting one bit to the block forming circuit (receiver) at regular intervals. The time intervals are dimensioned in such a manner that when the block boundaries are correct, the correlators detect this in time before the next shifting.

The ASYNC correlator here has no possibility for detecting the offset. The ASYNC correlator only determines whether the block boundaries are correct. This information is supplied to the state machine.

The SYNC correlator here has no possibility for detecting the offset. The SYNC correlator only determines whether the block boundaries are correct. This information is supplied to the state machine.

The state machine in FIG. 3: In state 1 (“asynchronous”), the shifting mechanism of the block forming circuit (receiver) is not suppressed. In state 2 (“synchronous and opposite end asynchronous”) and in state 3 (“both synchronous”), the shifting mechanism of the block forming circuit (receiver) is suppressed.

FIG. 4 shows a solution with synchronization after the decoder. The flags can be freely selected in this case but should have the conditions described above after the coding.

The encoder here receives the data blocks to be coded (block size N) from the block-synchronous switch and codes it into blocks with block size M. At the output, block-coded data are present. The block boundaries are known to the subsequent selection switch.

The ASYNC flag forming circuit forms a block which has the same length as a block to be coded or a multiple (block size k*N). The content of the block consists of the ASYNC flag. At the output, this data block is provided to the selection switch.

The SYNC flag forming circuit forms a block which has the same length as a block to be coded by the encoder, or a multiple (block size k*N). The content of the block consists of the SYNC flag. At the output, this data block is provided to the selection switch.

The block-synchronous switch: The state machine controls the selection of the data block to be forwarded from the 3 inputs (ASYNC flag forming circuit, SYNC flag forming circuit and block forming circuit (transmitter)). Switching is block-synchronous. (Switching only takes place at the block boundaries or flag boundaries, block size N, flag size k*N). The blocks present at the inputs are always sent complete. There are no gaps between the individual blocks. The selected blocks are forwarded to the “encoder”. It receives block-oriented data with block size N.

The transmitter output has no other function.

The receiver input receives the data of the opposite end and forwards them to the block forming circuit. The incoming data stream is still bit-oriented. However, it contains concatenated data blocks coded by the opposite end. However, no information about the block boundaries is forwarded.

The block forming circuit (receiver) here generates a block-oriented data stream from the bit-oriented data stream. This means that the decoder following the correlators also receives information on the block boundaries in addition to the data stream. The individual blocks all have the same length. The length of the data blocks corresponds to the length of a block to be decoded (block size M). The block forming circuit cannot check by itself whether these block boundaries, which initially have been arbitrarily assumed, are also correct. The block forming circuit, therefore, has a set input which is connected to the state machine and in each case one input which is connected to the respective correlator. The correlators can determine the correct position of the actual block boundaries with respect to the initially random block boundaries of the block forming circuit (offset) on the basis of the respective flag. Information relating to the actual block boundaries is present at both inputs. The set input makes it possible to select which of the two is to be accepted. After the setting, the block forming circuit is correctly set and the block boundaries now correspond to the actual block boundaries.

The decoder receives, at its input, block-oriented data (block size M, data and information relating to block boundaries). The block boundaries may be incorrect during the synchronization process. The decoder decodes data blocks and forwards the decoded data to the “receiver output” and to the two correlators (block size N).

The ASYNC correlator receives, at its input, block-oriented data blocks (data and information relating to block boundaries, block size M). The block boundaries may be incorrect during the synchronization process. If ASYNC flags are sent by the opposite end, this enables the correlator to detect that the ASYNC flag is sent. In addition, it is also capable of detecting the precise block boundaries by means of the “ASYNC flags.” This information is present at the output which is connected to the block forming circuit. The other output is connected to the state machine. It informs the state machine of whether or not the ASYNC flag has been received. Since a flag consists of k blocks (block size M), it always takes into consideration k successive blocks.

The SYNC correlator receives, at its input, block-oriented data blocks (data and information relating to block boundaries, block size M). The block boundaries may be incorrect during the synchronization process. If SYNC flags are sent by the opposite end, this enables the correlator to detect that the SYNC flag is sent. In addition, it can also detect the precise block boundaries by means of the “SYNC flags”. This information is present at the output which is connected to the block forming circuit. The other output is connected to the state machine. It informs the state machine of whether the SYNC flag has been received. Since a flag consists of k blocks (block size N), it always takes into consideration k successive blocks.

The states of the state machine are as follows: A reset places the state machine into the state 1 (“asynchronous”). In this state, the “block-synchronous switch” is set to accepting the “ASYNC flags.” As soon as one of the two correlators at the input signals that it has found a valid flag (ASYNC or SYNC flag), it changes into another state. If the flag found is an ASYNC flag, it changes into state 2 (“synchronous and opposite end asynchronous”). The state machine then initiates setting the correct block boundaries (“receiver block forming circuit”). This means that the acceptance of the block boundary information of the ASYNC correlator is initiated at the “receiver block forming circuit”. If the flag found is a SYNC flag, it changes into state 3 (“both synchronous”). The state machine then initiates setting the correct block boundaries (“receiver block forming circuit”). This means that the acceptance of the block boundary information of the SYNC correlator is initiated at the “receiver block forming circuit.” In state 2 (“synchronous and opposite end asynchronous”), the SYNC flag is then sent to the opposite end. This means that the “block-synchronous switch” receives corresponding information on the selection of the SYNC flag. If no further ASYNC flag is received in this state, this means that the opposite end is synchronous. The state machine changes into state 3 (“both synchronous”). With this transition, it is no longer necessary to set the “receiver block forming circuit” since the block boundaries were already correct in state 2 (“synchronous and opposite end asynchronous”). In state 3 (“both synchronous”), the coded data have been sent. This means that the “block-synchronous switch” receives information on the selection of the data from the block forming circuit. It is only possible to return from this state into state 1 by a reset. The state machine can be set to the initial state 1 (“asynchronous”) from each of the 3 states by a reset.

The reset input allows a reset signal to be input to the state machine.

I claim:

1. A method of synchronizing transmission devices in a block-coded bidirectional data transmission via a bit-oriented channel, wherein transmission devices are disposed at a transmitting end and at a receiving end, the method which comprises:
assuming, with the two transmission devices, an asynchronous synchronization state at a beginning of a data transmission and in each case transmitting first flags to a respectively opposite end, and first synchronizing each of the transmission devices to one of the first flags and further flags received thereby; and
upon a successful synchronization by one of the two transmission devices, transmitting the further flags to the opposite end until no further first flags are received by the opposite end and synchronism has thus been achieved at both transmission devices, and subsequently starting a data transmission.

2. The method according to claim 1, wherein the transmission devices are coding systems comprising one of block encoders and block decoders.

3. A synchronizing method, which comprises:
providing a first transmission device at a transmitting end and a second transmission device at a receiving end of a system enabled for block-coded bidirectional data transmission via a bit-oriented channel;
placing the first and second transmission devices into an asynchronous synchronization state at a beginning of a data transmission and transmitting first flags from the first transmission device to the second transmission device and from the second transmission device to the first transmission device, and wherein each of the transmission devices first synchronizes to one of the first flags and further flags received thereby; and
upon a successful synchronization by one of the first and second transmission devices, transmitting the further flags from the one transmission device to the other transmission device until no further first flags are received by the one transmission device, indicating that synchronism has been achieved at the first and second transmission devices and a data transmission between the first and second transmission device can be started.
